(19) United States
(12) Patent Application Publication
(10) Pub. No.: US 2021/0304219 A1
(43) Pub. Date: Sep. 30, 2021

(54) METHODS, EQUIPMENT AND STORAGE MEDIUM FOR UNMANNED AERIAL VEHICLE ACTIVATION AND UNBINDING

(71) Applicant: SZ DJI TECHNOLOGY CO., LTD., Shenzhen (CN)

(72) Inventors: Zuzheng ZHU, Shenzhen (CN); Wei YAN, Shenzhen (CN); Cheng ZOU, Shenzhen (CN); Bowen LI, Shenzhen (CN); Yuqi LIU, Shenzhen (CN)

(73) Assignee: SZ DJI TECHNOLOGY CO., LTD., Shenzhen (CN)

(21) Appl. No.: 17/151,661

(22) Filed: Jan. 19, 2021

Related U.S. Application Data
(63) Continuation of application No. PCT/CN2019/112011, filed on Oct. 18, 2019.

(51) Int. Cl. G06Q 30/00; G06F 21/44

(52) U.S. Cl. CPC G06Q 30/018; G06F 21/44

(57) ABSTRACT

Methods, equipment and storage medium for unmanned aerial vehicle (UAV) activation and unbinding can include: determining whether a current value of a real-name system flag of the UAV is a preset value; if so, displaying an activation confirmation page; when an activation confirmation operation is detected, sending a product serial code and a user account to a server; and according to activation result information sent by the server, activating the UAV.

### CROSS REFERENCE TO RELATED APPLICATION

The present application is a continuation of International Application No. PCT/CN2019/112011, filed Oct. 18, 2019, the entire contents of which is incorporated herein by reference in its entirety.

### TECHNICAL FIELD

The present disclosure relates to the technical field of unmanned aerial vehicles (UAVs), particularly relates to methods, equipment and storage medium for unmanned aerial vehicle (UAV) activation and UAV unbinding.

### BACKGROUND

With the rapid development of the UAV manufacturing industry, UAVs are experiencing a rapid growth in areas such as aerial surveys, power line inspections, natural gas (oil) pipeline inspections, forest fire prevention, disaster relief, and smart cities. Hence, more and more users are using UAVs. When users use UAVs for the first time, they need to activate UAVs first to avoid unactivated UAVs being used, which ensures the safety of UAVs and facilitates the management of UAVs by the Civil Aviation Administration. Currently, the activation of a UAV includes a real-name authentication process and a UAV binding process, where the real-name authentication process and the UAV binding process are separated and asynchronous. This can require a user to enter a user account and a mobile phone number twice, which is cumbersome, time-consuming and error-prone, resulting an unsatisfied user experience.

### SUMMARY

The present disclosure provides methods, equipment and storage medium for UAV activation and unbinding.

In a first aspect of the present disclosure, a UAV activation method is provided, which may include:
receiving, using an electronic processor, a current value of a real-name system flag, a current value of an activation flag, and a product serial code, sent by a UAV, and determining, using the electronic processor, whether the current value of the real-name system flag is a preset value;
when the current value of the real-name system flag is determined to be the preset value, displaying, using the electronic processor, an activation confirmation page, wherein the activation confirmation page comprises a user account;
when an activation confirmation operation of a user on the activation confirmation page is detected, sending, using the electronic processor, the product serial code and the user account to a server system corresponding to the current value of the activation flag so that the server system binds the product serial code with the user account; and
receiving activation result information sent by the server system, and activating the UAV according to the activation result information, using the electronic processor.

In a second aspect of the present disclosure, a UAV unbinding method is provided, which may include:
receiving a current value of a real-name system flag sent by a UAV, and determining whether the current value of the real-name system flag is a preset value;
if the current value of the real-name system flag is not the preset value, displaying an unbinding page, wherein the unbinding page displays a bound user account;
when an unbinding operation, triggered by a user, on the unbinding page is detected, sending the bound user account to a user server, and receiving a short message verification code returned by the user server based on the bound user account;
acquiring the short message verification code entered by the user on the unbinding page, and when an unbinding confirmation operation of the user is detected, determining whether to trigger an unbinding instruction according to the short message verification code; and
if the unbinding instruction is triggered, sending the unbinding instruction to the UAV, so that the UAV release a binding relationship between the bound user account and the UAV based on the unbinding instruction.

In a third aspect of the present disclosure, a control terminal is further provided. The control terminal may include a storage medium and a processor, wherein:
the storage medium is configured to store a computer program; and
the processor is configured to execute the computer program and, when executing the computer program, implement a UAV activation method as described above.

In a fourth aspect of the present disclosure, a control terminal is further provided. The control terminal may include a storage medium and a processor, wherein:
the storage medium is configured to store a computer program comprising computer-executable instructions; and
the processor is configured to execute the computer program and, when executing the computer program, receive a current value of a real-name system flag, a current value of an activation flag, and a product serial code sent by an unmanned aerial vehicle (UAV), and determine whether the current value of the real-name system flag is a preset value; display an activation confirmation page when the current value of the real-name system flag is the preset value, wherein the activation confirmation page comprises a user account; when an activation confirmation operation of a user on the activation confirmation page is detected, send the product serial code and the user account to a server system corresponding to the current value of the activation flag so that the server system binds the product serial code with the user account; and receive activation result information sent by the server system corresponding to the current value of the activation flag, and activate the UAV according to the activation result information.

In a fifth aspect of the present disclosure, an unmanned aerial vehicle (UAV) is provided. The UAV may include a storage medium and a processor, wherein:
the storage medium is configured to store a computer program; and
the processor is configured to execute the computer program and, when executing the computer program, implement the following steps:
acquiring a current value of a real-name system flag and/or a current value of an activation flag, and determining whether the current value of the real-name system flag and/or the current value of the activation flag is a preset value;
if the current value of the real-name system flag and/or the current value of the activation flag is the preset value, sending the current value of the real-name system flag, the current value of the activation flag and a product serial code to a control terminal, wherein the control terminal generates a corresponding activation instruction based on the current value of the real-name system flag, the current value of the activation flag and the product serial code, and sends the activation instruction to the UAV; and
receiving the activation instruction sent by the control terminal, and activating the UAV according to the activation instruction.

In a sixth aspect of the present disclosure, a computer-readable storage medium is provided. The computer-readable storage medium may store a computer program, and when the computer program is executed by a processor, the processor implements the aforementioned UAV activation method, or UAV unbinding method described above.

The present disclosure provides a UAV activation method, a UAV unbinding method, equipment and storage medium for UAV activation and unbinding. By receiving a current value of a real-name system flag, a current value of an activation flag and a product serial code sent by a UAV, when the current value of the real-name system flag is a preset value, an activation confirmation page containing a user account is displayed, and then when an activation confirmation operation of a user in the activation confirmation page is detected, the product serial code and the user account are sent to a server, the server binds the product serial code with the user account, and the UAV is activated according to received binding result information returned by the server, which can effectively reduce time required for a user to activate the UAV.

It should be understood that the above general description and the following detailed description are only exemplary and explanatory, and should not be used to limit the present disclosure.

### BRIEF DESCRIPTION OF THE DRAWINGS

In order to explain the technical solutions of embodiments of the present disclosure more clearly, the drawings used in the present disclosure are briefly introduced as follow. The drawings in the following description are some exemplary embodiments of the present disclosure.

FIG. 1 illustrates a schematic step diagram of a UAV activation method according to an embodiment of the present disclosure;

FIG. 2 illustrates a schematic diagram of an activation confirmation page according to an embodiment of the present disclosure;

FIG. 3 illustrates a schematic step diagram of a UAV activation method according to another embodiment of the present disclosure;

FIG. 4 illustrates is a schematic step diagram of a UAV unbinding method according to an embodiment of the present disclosure;

FIG. 5 illustrates a schematic diagram of an unbinding page according to an embodiment of the present disclosure;

FIG. 6 illustrates is a schematic diagram of an updated unbinding page according to an embodiment of the present disclosure;

FIG. 7 illustrates a schematic structure block diagram of a control terminal according to an embodiment of the present disclosure;

FIG. 8 illustrates a schematic structure block diagram of a UAV according to an embodiment of the present disclosure;

FIG. 9 illustrates a schematic step diagram of an activation operation performed by a UAV according to an embodiment of the present disclosure; and

FIG. 10 illustrates a schematic structure block diagram of a system according to an embodiment of the present disclosure.

### DETAILED DESCRIPTION

The flowchart(s) and diagram(s) shown in the drawings are only examples, and do not necessarily include all components, elements, contents and/or operations/steps, nor do they have to be executed in the described or specific order. For example, some operations/steps can also be disassembled, combined or partially combined; therefore, the actual execution order may be changed or modified according to actual conditions.

Hereinafter, some exemplary embodiments of the present disclosure will be described in detail with reference to the accompanying drawings. In the case of no conflict, the components, elements, operations/steps and other features disclosed in embodiments may be combined with each other.

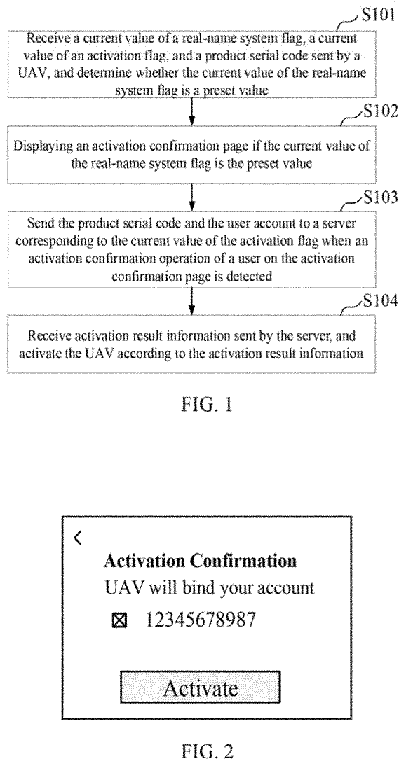

FIG. 1 illustrates a schematic step diagram of a UAV activation method according to one embodiment of the present disclosure. The UAV activation method can be carried out in a control terminal to activate a UAV. The control terminal may include, but is not limited to, a remote control, a ground control platform, a mobile phone, a tablet, a laptop, a PC computer, or the like. The UAV may include, but is not limited to, a rotary wing UAV, such as a quadrotor UAV, a hexarotor UAV, and an octorotor UAV. The UAV may also be a fixed-wing type UAV, or a combination of a rotary-wing type and a fixed-wing UAV, which is not limited herein.

Specifically, as shown in FIG. 1, the UAV activation method may include steps S101 to S104. Some or all of the method of FIG. 1 can be performed by a control terminal as described herein.

Step S101 may include receiving a current value of a real-name system flag, a current value of an activation flag, and a product serial code sent by a UAV, and determining whether the current value of the real-name system flag is a preset value.

The current value of the real-name system flag, the current value of the activation flag and the product serial code are stored in the UAV. The real-name system flag is used to identify whether the UAV has been real-named, the activation flag is used to identify whether the UAV has been activated for the first time, and the product serial code used to uniquely identify the UAV. Generally, if a value of the real-name system flag is the preset value, the UAV is not real-named; if a value of the real-name system flag is not the preset value, the UAV is already real-named. If the value of the activation flag is the preset value, the UAV has not been activated for the first time, and if the value of the activation flag is not the preset value, the UAV has been activated for the first time.

When the UAV is turned on for the first time, a communication connection between the UAV and a control terminal is established. The UAV can sends a product serial code to the control terminal, and the control terminal receives the product serial code sent by the UAV and sends the product serial code to a server, and the server acquires an online real-name system identifier and an online activation identifier corresponding to the product serial code; the control terminal receives the online real-name system identifier and the online activation identifier, returned by the server, based on the product serial code. And, based on the online real-name system identifier and the online activation identifier, the control terminal sends a flag configuration instruction to the UAV, so that the UAV may configure the real-name system flag and activation flag of the UAV based on the flag configuration instruction. Among them, the online real-name system identifier is used to identify whether the state of the UAV in the server is a real-named state, and the online activation identifier is used to identify whether the state of the UAV in the server is in an activation state for the first time.

After the UAV is configured with the real-name system flag and activation flag, each time the UAV establishes a communication connection with the control terminal, the UAV determines whether the current value of the real-name system flag and/or activation flag is a preset value. If the current value of the real-name system flag and/or the current value of the activation flag is the preset value, then the current value of the real-name system flag, the current value of the activation flag and the product serial code are sent to the control terminal. The control terminal receives the current value of the real-name system flag, the current value of the activation flag and the product serial code sent by the UAV, and determines whether the current value of the real-name system flag is a preset value. It should be noted that the preset value mentioned above may be set based on actual conditions, and the present disclosure does not specifically limit this. For example, the preset value may be 0.

Step S102 may include displaying an activation confirmation page if the current value of the real-name system flag is the preset value, wherein the activation confirmation page displays a user account.

If the current value of the real-name system flag is the preset value, it can be determined that the UAV is in an inactivated state and an unreal-named state. The control terminal displays an activation confirmation page that may display a user account, which may include, but is not limited to, an email address and/or a mobile phone number.

In one embodiment of the present disclosure, if the current value of the real-name system flag is the preset value, it is determined whether the control terminal is in an account logged-in state, if the control terminal is in the account logged-in state, an activation confirmation page is displayed; if the control terminal is not in the account logged-in state, an account login page is displayed to remind a user to log in to an account or to register an account; when a registration instruction triggered by the user on the account login page is detected, a corresponding account registration page is displayed according to the registration instruction; a user account, a user password, and a verification code entered on the account registration page by a user are collected, and the verification code is verified; when the verification code passes verification, an account login operation is performed according to the user account and the user password, so that the control terminal is in an account logged-in state. When the control terminal is not in an account logged-in state, the user can be reminded to log in or register an account, and the account can be logged in or registered timely during a process of activating the UAV, so that the control terminal is in an account logged-in state and can continue to activate the UAV and there can be no need to activate the UAV from scratch.

In another embodiment, a control terminal acquire a user account and a user password entered by a user on an account login page, and when detecting a user login operation on the account login page, verifies the user account and user password. When the user account and user password pass verification, an account login operation is performed according to the user account and user password, so that the control terminal is in an account logged-in state.

In yet another embodiment, a control terminal can acquires a user account and a user password entered by a user on an account registration page, and when the user account and user password entered pass verification, and determines whether the user account is a mobile phone number; if the user account is a mobile phone number, a verification code input box and a verification code acquisition control module are displayed; when a touch operation of a user on the verification code acquisition control module is detected, the user account is sent to a user server, and a verification code returned by the user server is received; the verification code in the verification code input box entered by the user is collected, the control terminal sends the verification code and the user account to the user server, and receives the verification result of the verification code returned by the user server. When the registered user account is a mobile phone number, the user account can thus be registered relatively quickly.

In yet another embodiment, if the user account is not a mobile phone number, a mobile phone number input box, a verification code input box, and a verification code acquisition control module are displayed; when a touch operation of a user on the verification code acquisition control module is detected, the mobile phone number in the mobile phone number input box is sent to a user server; a verification code returned by the user server is received, and the verification code entered by the user in the verification code input box is acquired; the verification code and the mobile phone number are sent to the user server, and a verification result of the verification code returned by the user server is received. The user server acquires an online verification code corresponding to the user account/mobile phone number, and compares the online verification code with the verification code. If the online verification code is the same as the verification code, the verification code is determined to pass verification. If the online verification code is different from the verification code, it is determined that the verification code fails verification.

Step S103 may include sending the product serial code and the user account to a server system corresponding to the current value of the activation flag when an activation confirmation operation of a user on the activation confirmation page is detected, so that the server system may bind the product serial code with the user account.

When an activation confirmation operation of the user on the activation confirmation page is detected, the product serial code and user account are sent to the server system corresponding to the current value of the activation flag, so that the server system binds the product serial code with the user account. The activation confirmation operation is a touch operation of the user on an activation confirmation control module on the activation confirmation page. FIG. 2 illustrates a schematic diagram of an activation confirmation page according to one embodiment of the present disclosure. As shown in FIG. 2, the activation confirmation page displays a user account, activation reminder information, and an activation confirmation control module.

In one embodiment of the present disclosure, the control terminal determines whether a current value of an activation flag is a preset value; if the current value of the activation flag is the preset value, the product serial code and the user account are uploaded to an activation server of the server system. The activation server binds the user account with the product serial code, and when the binding is completed, the control terminal sends the user account and the product serial code to a real-name system server, and the real-name system server binds the user account with the product serial code; if the current value of the activation flag is not the preset value, the control terminal uploads the product serial code and the user account to the real-name system server for the real-name system server to bind the user account with the product serial code. After the activation server binds the user account with the product serial code, a binding record in the activation server is updated. At this time, the online activation identifier corresponding to the product serial code may be 1, which can indicate that the state of a UAV is a first time activation state in the activation server. After the real-name system server binds the user account with the product serial code, a new binding record is added to the real-name system server. At this time, the online real-name system identifier corresponding to the product serial code may be 1, which can indicate the state of the UAV in the activation server is a real-named state.

Step S104 may include receiving activation result information sent by the server system, and activating the UAV according to the activation result information.

The control terminal receives the activation result information sent by the server system, and activates the UAV according to the activation result information, that is, according to the activation result information, determines a value of the real-name system flag and a value of the activation flag of the UAV, and send the value of the real-name system flag and the value of the activation flag to the UAV so that the UAV may update the real-name system flag and the activation flag according to the value of the real-name system flag and the value of the activation flag, and activates the UAV.

In one embodiment of the present disclosure, the control terminal receives an online activation identifier returned by the activation server and an online real-name system identifier returned by the real-name system server; the activation flag of UAV is updated according to the online activation identifier, and the real name system flag of UAV is updated according to the online real-name system identifier, and a bound account of the UAV is updated to the user account; or the control terminal receives an online real-name system identifier returned by the real-name system server, updates the real-name system flag of the UAV according to the online real-name system identifier, and updates a bound account of the UAV to the user account.

In the UAV activation method disclosed above, the method can include: receiving a current value of a real-name system flag, a current value of an activation flag and a product serial code sent by a UAV; displaying an activation confirmation page containing a user account when the current value of the real-name system flag is a preset value; sending the product serial code and a user account to a server when an activation confirmation operation of a user on the activation confirmation page is detected, so that the server binds the product serial code with the user account; and activating the UAV according to received binding result information returned by the server system, which can effectively reduce time required for the user to activate the UAV and relatively quickly activate the UAV.

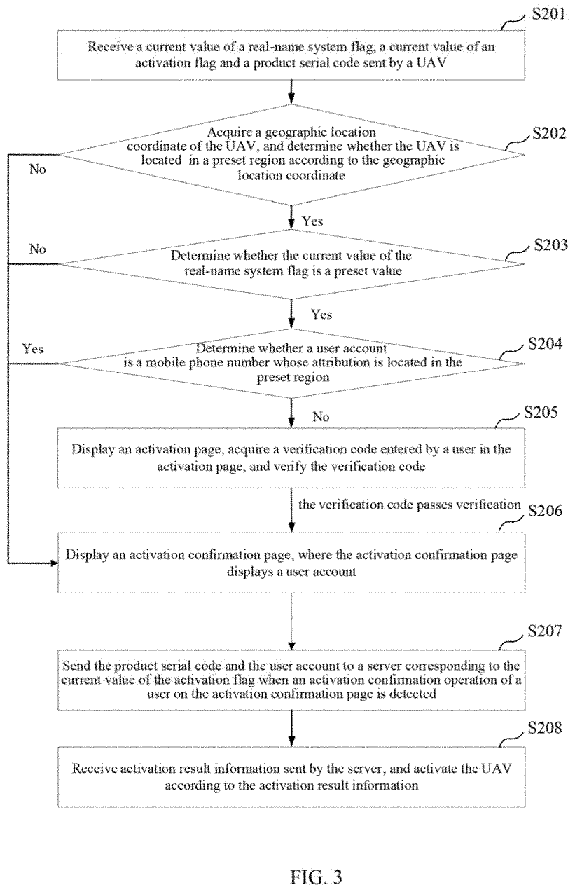

FIG. 3 illustrates a schematic step diagram of a UAV activation method according to another embodiment of the present disclosure.

Specifically, as shown in FIG. 3, the UAV activation method may include steps S201 to S208. Some or all of the method of FIG. 2 can be performed by a control terminal as described herein.

Step S201 may include: receiving a current value of a real-name system flag, a current value of an activation flag and a product serial code sent by a UAV.

The current value of the real-name system flag, the current value of the activation flag and the product serial code are stored in the UAV. In general, the real-name system flag is used to identify whether the UAV has been real-named, the activation flag is used to identify whether the UAV has been activated for the first time, and the product serial code is used to uniquely identify the UAV. If the value of the real-name system flag is a preset value, the UAV is not real-named. If the value of the real-name system flag is not the preset value, the UAV is already real-named. If the value of the activation flag is a preset value, the UAV has not been activated for the first time, and if the value of the activation flag is not the preset value, the UAV has been activated for the first time.

After the UAV is configured with the real-name system flag and activation flag, each time the UAV establishes a communication connection with a control terminal, the UAV determines whether the current value(s) of the real-name system flag and/or activation flag is a preset value. If the current value(s) of the real-name system flag and/or the activation flag is the preset value, the UAV sends the current value of the real-name system flag, the current value of the activation flag and the product serial code to the control terminal, and the control terminal receives the current value of the real-name system flag, the current value of the activation flag and the product serial code sent by the UAV.

Step S202 may include: acquiring a geographic location coordinate of the UAV, and determining whether the UAV is located in a preset region according to the geographic location coordinate.

The control terminal acquires a geographic location coordinate of the UAV, and determines whether the UAV is located in a preset region according to the geographic location coordinate, that is, the control terminal acquires a geographic location coordinate set corresponding to the preset region, and determines whether the geographic location coordinate is located in the geographic location coordinate set. If the geographic location coordinate is located in the geographic location coordinate set, it can be determined that the UAV is located in the preset region. If the geographic location coordinate is not located in the geographic location coordinate set, it can be determined that the UAV is not located in the preset region. For example, the preset region may be Mainland China.

Step S203 may include: if the UAV is located in the preset region, determining whether the current value of the real-name system flag is a preset value.

If the UAV is located in the preset region, it is determined whether the current value of the real-name system flag is a preset value, i.e., it is determined whether the UAV needs to be activated. It should be noted that the preset value may be set according to actual conditions, and the present disclosure does not specifically limit this. For example, the preset value may be 0. In one embodiment, if the UAV is not located in the preset region, step S206 is executed to display an activation confirmation page, where the activation confirmation page displays a user account.

Step S204 may include: if the current value of the real-name system flag is a preset value, determining whether a user account is a mobile phone number whose attribution is located in the preset region.

If the current value of the real-name system flag is the preset value, it is further determined whether the user account is a mobile phone number attributable to the preset region, that is, a preset regular expression is acquired, and whether the use account is a mobile phone number is determined according to the preset regular expression. If the user account is a mobile phone number, whether the location attribution of the user account is located in the preset region is determined, if the location attribution of the user account is located in the preset region, it can be determined that the user account is a mobile phone number attributable to the preset region. If the location attribution of the user account is not located in the preset region, it can be determined that the user account is not a mobile phone number whose attribution is located in the preset region. If the current value of the real-name system flag is not the preset value, step S206 is executed to display the activation confirmation page.

In one embodiment of the present disclosure, if the current value of the real-name system flag is the preset value, a motor-locking instruction is sent to the UAV so that the UAV may set UAV's one or more motors to be in a locked state based on the motor-locking instruction. By locking the UAV's one or more motors in a locked state when the UAV is not activated, it can ensure that a user cannot use the UAV when the UAV is not activated, preventing unauthorized flying and improving safety.

Step S205 may include: if the user account is not a mobile phone number whose attribution is located in the preset region, displaying an activation page, acquiring a verification code entered by a user in the activation page, and verifying the verification code.

If the user account is not a mobile phone number whose attribution is located in the preset region, an activation page is displayed, where the activation page displays a mobile phone number input box, a verification code input box, and a verification code acquisition control module. When a touch operation of a user of the code acquisition control module is detected, a mobile phone number in the mobile phone number input box is sent to a user server; the verification code returned by the user server is received, and the verification code entered by the user in the verification code input box is acquired. If the user account is a mobile phone number whose attribution is located in the preset region, step S206 is executed to display an activation confirmation page.

Step S206 may include displaying an activation confirmation page when the verification code passes verification, where the activation confirmation page displays a user account.

After the verification code is obtained, the verification code is verified, and when the verification code passes verification, an activation confirmation page is displayed. The method of verifying the verification code is: sending the entered verification code and the mobile phone number to the user server, so that the user server may acquire an online verification code corresponding to the mobile phone number, and compare the online verification code with the verification code to obtain a verification result of the verification code; the verification result returned by the user server is received, and if the verification result is a pass, it is determined that the verification code passes verification, and if the verification result is a verification failure, it is determined that the verification code has not passed verification.

Step S207 may include: sending the product serial code and the user account to a server system corresponding to the current value of the activation flag when an activation confirmation operation of a user on the activation confirmation page is detected, so that the server system binds the product serial code with the user account.

When an activation confirmation operation of a user on the activation confirmation page is detected, the product serial code and user account are sent to the server system corresponding to the current value of the activation flag, so that the server binds the product serial code with the user account. The activation confirmation operation is a touch operation of the user on an activation confirmation control module on the activation confirmation page.

Step S208 may include receiving activation result information sent by the server system, and activating the UAV according to the activation result information.

The control terminal receives activation result information sent by the server system, and activates the UAV according to the activation result information, that is, according to the activation result information, the control terminal determines a value of the real-name system flag and a value of the activation flag of the UAV, and sends the value of the real-name system flag and the value of the activation flag to the UAV so that the UAV may update the real-name system flag and the activation flag based on the value of the real-name system flag and the value of the activation flag, and activates the UAV.

In one embodiment of the present disclosure, after the UAV is activated, a motor-unlocking instruction is sent to the UAV, so that the UAV may set UAV's one or more motors to be in an unlocked state according to the motor-unlocking instruction. Once the UAV is activated, the one or more motors of the UAV are unlocked, so that the UAV may be used by the user.

In the UAV activation method disclosed above, the method may include: receiving a current value of a real-name system flag, a current value of an activation flag and a product serial code sent by a UAV; if the UAV is not located in a preset region, or the UAV is located in the preset region, and the current value of the real-name system flag is a preset value, displaying an activation confirmation page containing a user account; sending the product serial code and the user account to a server system when an activation confirmation operation of a user on the activation confirmation page is detected, and binding the product serial code with the user account by the server system; and activating the UAV according to received binding result information returned by the server system, which can effectively reduce the time required for the user to activate the UAV and thus activate the UAV relatively quickly.

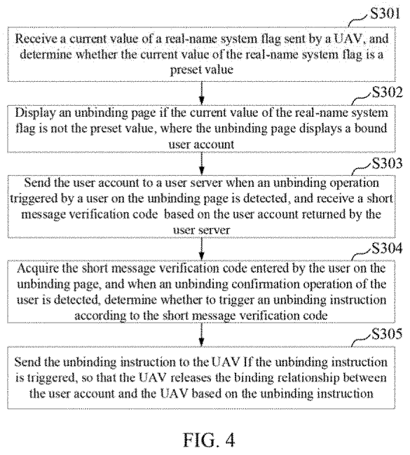

FIG. 4 illustrates a schematic step diagram of a UAV unbinding method according to an embodiment of the present disclosure. The UAV unbinding method may be carried out by a control terminal to unbind the UAV. The control terminal may include, but is not limited to, a remote control, a ground control platform, a mobile phone, a tablet, a laptop, a PC computer, etc. The UAV may include, but is not limited to, a rotary wing UAV, such as a quadrotor UAV, a hexarotor UAV, and an octorotor UAV. The UAV may also be a fixed-wing UAV, or a combination of a rotary-wing type and a fixed-wing UAV, which is not limited herein.

Specifically, as shown in FIG. 4, the UAV unbinding method may include steps S301 to S305.

Step S301 may include: receiving a current value of a real-name system flag sent by a UAV, and determining whether the current value of the real-name system flag is a preset value.

When a control terminal detects a trigger operation, operated by a user, of an unbinding control key, the control terminal sends a real-name system flag acquisition request to a UAV, and the UAV sends the current value of the real-name system flag to the control terminal based on the acquisition request. The control terminal receives the current value of the real-name system flag sent by the UAV, and determines whether the current value of the real-name system flag is a preset value. It should be noted that the preset value may be set based on actual conditions, and the present disclosure does not specifically limit this. For example, the preset value may be 0. The unbinding control key may be one of a sliding control key, a click control key, and a trigger control key.

Step S302 may include: displaying an unbinding page if the current value of the real-name system flag is not the preset value, where the unbinding page displays a bound user account.

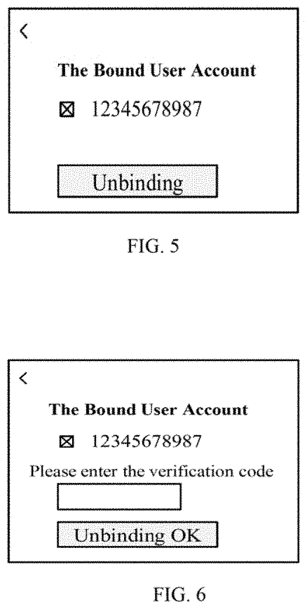

If the current value of the real-name system flag is not the preset value, the unbinding page is displayed; if the current value of the real-name system flag is the preset value, an activation confirmation page is displayed, where the activation confirmation page displays a user account; when an activation confirmation operation of a user on the activation confirmation page is detected, a product serial code and the user account are sent to a server corresponding to a current value of an activation flag, so that the server may bind the product serial code with the user account; and then the UAV is activated according to received activation result information returned by a server system. The unbinding page displays a bound user account. FIG. 5 illustrates a schematic diagram of an unbinding page according to one embodiment of the present disclosure. As shown in FIG. 5, the unbinding page displays an unbinding control module and a user account.

Step S303 may include: sending the user account to a user server when an unbinding operation triggered by a user on the unbinding page is detected, and receiving a short message verification code based on the user account returned by the user server.

When detecting an unbinding operation triggered by a user on the unbinding page, the control terminal sends the user account to the user server; the user server acquires a mobile phone number corresponding to the user account, and sends a short message verification code to the mobile phone number; the control terminal receives the short message verification code returned by the user server based on the user account. In one embodiment, when detecting an unbinding operation triggered by a user on the unbinding page, the control terminal sends the user account to the user server, and the user server determines whether the user account is a mobile phone number, and if the user account is a mobile phone number, according to the mobile phone number, issues a short message verification code to the control terminal. If the user account is not a mobile phone number, then the user server acquires a mobile phone number corresponding to the user account, and, according to the mobile phone number, issues a short message verification code to the control terminal.

In one embodiment of the present disclosure, the control terminal determines whether one or more motors of the UAV are in a rotating state; if the one or more motors of the UAV are in a rotating state, a preset reminder message is output to remind the user that the one or more motors of the UAV are in a rotating state and unbinding the UAV is not allowed. In the process of unbinding the UAV, if the one or more motors of the UAV are rotating, it is not allowed to unbind the UAV, which may ensure the safety of the UAV.

In another embodiment of the present disclosure, if one or more motors of the UAV are not in a rotating state, a motor-locking instruction is sent to the UAV, so that the UAV may set the one or more motors of the UAV to be in a locked state based on the motor-locking instruction. By locking the one or more motors of the UAV, the safety of the UAV may be guaranteed.

Step S304 may include: acquiring the short message verification code entered by the user on the unbinding page, and when an unbinding confirmation operation of the user is detected, determining whether to trigger an unbinding instruction according to the short message verification code.

When an unbinding operation triggered by the user on the unbinding page is detected, the unbinding page is updated, where the updated unbinding page displays a verification code input box and an unbinding confirmation control module; the control terminal acquires a short message verification code entered by the user on the unbinding page, i.e., acquiring the short message verification code entered by the user in the verification code input box; when an unbinding confirmation operation of the user is detected, the control terminal determines whether to trigger an unbinding instruction according to the short message verification code. For example, the unbinding confirmation operation may be a touch operation of the user on the unbinding confirmation control module on the unbinding page. FIG. 6 illustrates a schematic diagram of an updated unbinding page according to one embodiment of the present disclosure. As shown in FIG. 6, the updated unbinding page displays a user account, a verification code input box, and an unbinding confirmation control module.

In one embodiment of the present disclosure, the control terminal sends a short message verification code to a user server, which may be referred to herein as a server system, so that, when the short message verification code passes verification, the user server sends the user account to a real-name system server for the real-name system server to release a binding relationship between the product serial code corresponding to the user account and the user account; the control terminal receives response information sent by the real-name system server, determines whether the response information is a preset response information, and when the response information is the preset response information, triggers an unbinding instruction. When the response information is not the preset response information, the unbinding instruction is not triggered.

Step S305 may include: sending the unbinding instruction to the UAV if the unbinding instruction is triggered, so that the UAV releases the binding relationship between the user account and the UAV based on the unbinding instruction.

If the unbinding instruction is triggered, the unbinding instruction is sent to the UAV, so that the UAV may release the binding relationship between the user account and the UAV based on the unbinding instruction. It can quickly change the binding relationship between the UAV and the user account.

In one embodiment of the present disclosure, unbinding result information returned by the UAV is received, and based on the unbinding result information, it is determined whether the binding relationship between the user account and the UAV has been released. If the binding relationship between the user account and the UAV has been released, a motor-unlocking instruction is sent to the UAV so that the UAV may set UAV's one or more motors to be in an unlocked state based on the motor-unlocking instruction. After the UAV is unbound, the one or more motors are unlocked timely to keep the UAV in a clean state so that subsequent users can quickly activate the UAV.

In the UAV unbinding method provided herein, when a UAV needs to be unbound, an unbinding page is displayed, and when an unbinding operation triggered by a user on the unbinding page is detected, a user account is sent to a user server; a short message verification code returned by the user server is received; the short message verification code entered by the user on the unbinding page is acquired; when the user's unbinding confirmation operation is detected, it is determined whether to trigger an unbinding instruction according to the short message verification code; the unbinding instruction is sent to the UAV to release the binding relationship between the user account and the UAV when the unbinding instruction is triggered. The entire unbinding process is clear and concise, and the UAV can be unbound quickly to improve user experience.

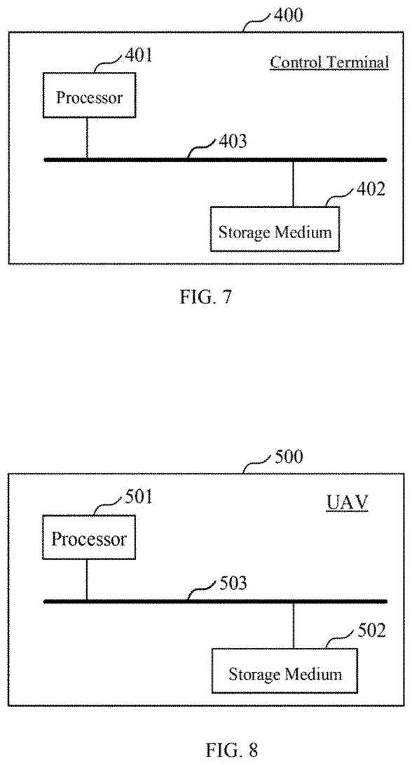

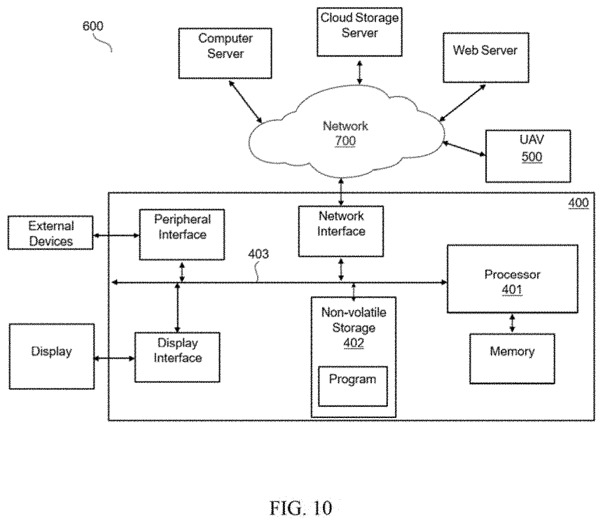

FIG. 7 illustrates a schematic structure block diagram of a control terminal 400 according to an embodiment of the present disclosure. In an embodiment, the control terminal 400 may include, but is not limited to, a remote control, a ground control platform, a mobile phone, a tablet computer, a notebook computer, a PC computer, and the like. Further, the control terminal 400 may include a processor 401 and a storage medium 402 connected with the processor 401 via a bus 403, which may be, for example, an I2C (Inter-integrated Circuit) bus. The control terminal 400 can be part of a system 600 shown in FIG. 10.

The processor 401 may be, but is not limited to, a micro-controller unit (MCU), a central processing unit (CPU), a digital signal processor (DSP), or the like.

The storage medium 402 may be, but is not limited to, a Flash chip, a read-only memory (ROM), a disk, an optical disk, a U disk, a mobile hard disk, or the like.

In some embodiments of the present disclosure, the processor 401 is configured to run a computer program stored in the storage medium 402 to:

receive a current value of a real-name system flag, a current value of an activation flag, and a product serial code sent by a UAV, and determine whether the current value of the real-name system flag is a preset value;

display an activation confirmation page if the current value of the real-name system flag is the preset value, where the activation confirmation page displays a user account;

send the product serial code and the user account to a server system corresponding to the current value of the activation flag when an activation confirmation operation of a user on the activation confirmation page is detected, so that the server system binds the product serial code with the user account; and

receive activation result information sent by the server system, and activate the UAV according to the activation result information.

In one embodiment of the present disclosure, before the processor 401 implements receiving a current value of a real-name system flag, a current value of an activation flag, and a product serial code sent by a UAV, the processor 401 may be further configured to:

receive a product serial code sent by the UAV, and send the product serial code to the server system;

receive an online real-name system identifier and an online activation identifier returned by the server system based on the product serial code; and

send a flag configuration instruction to the UAV according to the online real-name system identifier and the online activation identifier, so that the UAV configures the real-name system flag and the activation flag of the UAV according to the flag configuration instruction.

In one embodiment of the present disclosure, before the processor 401 implements determining whether the current value of the real-name system flag is a preset value, the processor 401 may be further configured to:

acquire a geographic location coordinate of the UAV, and determine whether the UAV is located in a preset region according to the geographic location coordinate; and

determine whether the current value of the real-name system flag is a preset value if the UAV is located in the preset region.

In one embodiment of the present disclosure, after the processor 401 implements determining whether the current value of the real-name system flag is a preset value if the UAV is located in the preset region, the processor 401 may be further configured to:

determine whether the user account is a mobile phone number whose attribution is located in the preset region if the current value of the real-name system flag is the preset value;

display an activation page if the user account is not a mobile phone number whose attribution is located in the preset region, acquire a verification code entered by the user on the activation page, and verify the verification code; and

display the activation confirmation page when the verification code passes verification.

In one embodiment of the present disclosure, after the processor 401 implements determining whether the user account is a mobile phone number whose attribution is located in the preset region, the processor 401 may be further configured to:

display the activation confirmation page if the user account is a mobile phone number whose attribution is located in the preset region.

In one embodiment of the present disclosure, after the processor 401 implements determining whether the UAV is located in a preset region according to the geographic location coordinate, the processor 401 may be further configured to implement:

display the activation confirmation page if the UAV is not located in the preset region.

In one embodiment of the present disclosure, before the processor 401 implements displaying an activation confirmation page, the processor 401 may be further configured to:

determine whether a control terminal is in an account logged-in state if the current value of the real-name system flag is the preset value; and

display the activation confirmation page if the control terminal is in the account logged-in state, where the activation confirmation page displays a logged-in user account.

In one embodiment of the present disclosure, after the processor 401 implements determining whether a control terminal is in an account logged-in state, the processor 401 may be further configured to implement:

display an account login page to remind a user to log in or register an account if the control terminal is not in the account logged-in state;

when a registration instruction triggered by the user on the account login page is detected, display an corresponding account registration page according to the registration instruction;

acquire a user account, a user password and a verification code entered by the user on the account registration page, and verify the verification code; and

when the verification code passes verification, perform an account login operation according to the user account and the user password, so that the control terminal is in the account logged-in state.

In one embodiment of the present disclosure, when the processor 401 implements sending the product serial code and the user account to a server corresponding to the current value of the activation flag so that the server binds the product serial code and the user account, the processor 401 is configured to:

determine whether the current value of the activation flag is a preset value;

if the current value of the activation flag is the preset value, upload the product serial code and the user account to an activation server so that the activation server may bind the user account with the product serial code, and when the binding is completed, send the user account and the product serial code to a real-name system server so that the real-name system server binds the user account with the product serial code; and

if the current value of the activation flag is not the preset value, upload the product serial code and the user account to the real-name system server so that the real-name system server binds the user account with the product serial code.

In one embodiment of the present disclosure, when the processor 401 implements receiving activation result information sent by the server, and activating the UAV according to the activation result information, the processor 401 may be further configured to:

receive an online activation identifier returned by the activation server and an online real-name system identifier returned by the real-name system server;

update the activation flag of the UAV according to the online activation identifier, update the real-name system flag of the UAV according to the online real-name system identifier, and update a bound account of the UAV to the user account; or

receive the online real-name system identifier returned by the real-name system server, update the real-name system flag of the UAV according to the online real-name system identifier, and update the bound account of the UAV to the user account.

In one embodiment of the present disclosure, the processor 401 may be further to configured to:

if the current value of the real-name system flag is the preset value, send a motor-locking instruction to the UAV, so that the UAV may set motors of the UAV to be in a locked state according to the motor-locking instruction.

In one embodiment of the present disclosure, after the processor 401 implements activating the UAV according to the product serial code, the user account, and the current value of the activation flag, the processor 401 may be further configured to:

send a motor-unlocking instruction to the UAV after the UAV is activated, so that the UAV may set motors of the UAV to be in an unlocked state according to the motor-unlocking instruction.

In some embodiments of the present disclosure, the processor 401 is configured to execute a computer program stored in the storage medium 402 to:

receive a current value of the real-name system flag sent by a UAV, and determine whether the current value of the real-name system flag is a preset value;

display an unbinding page if the current value of the real-name system flag is not the preset value, where the unbinding page displays a bound user account;

send a user account to a user server when an unbinding operation triggered by a user on the unbinding page is detected, and receive a short message verification code returned by the user server based on the user account;

acquire the short message verification code entered by the user on the unbinding page, and when an unbinding confirmation operation of the user is detected, determine whether to trigger an unbinding instruction according to the short message verification code; and

send the unbinding instruction to the UAV when the unbinding instruction is triggered, so that the UAV may release binding relationship between the user account and the UAV according to the unbinding instruction.

In one embodiment of the present disclosure, when the processor 401 implements determining whether to trigger an unbinding instruction according to the short message verification code, the processor 401 may be configured to:

send the short message verification code to a user server, so that when the short message verification code passes verification, the user server sends a user account to a real-name system server, and the real-name system server release binding relationship between a product serial code corresponding to the user account and the user account; and

receive response information sent by the real-name system server, determine whether the response information is a preset response information, and trigger an unbinding instruction when the response information is the preset response information.

In one embodiment of the present disclosure, after the processor 401 implements displaying an unbinding page if the current value of the real-name system flag is not the preset value, the processor 401 may be further configured to:

determine whether motors of the UAV are in a rotating state;

output a preset reminder message to remind the user that the motors of the UAV are in the rotating state and unbinding the UAV is not allowed if the motors of the UAV is in the rotating state.

In one embodiment of the present disclosure, after the processor 401 implements determining whether motors of the UAV are in a rotating state, the processor 401 may be further configured to:

send a motor-locking instruction to the UAV if the motors of the UAV are not in the rotating state, so that the UAV may set the motors of the UAV to be in a locked state according to the motor-locking instruction.

In one embodiment of the present disclosure, after the processor 401 implements sending the unbinding instruction to the UAV when the unbinding instruction is triggered so that the UAV may release binding relationship between the user account and the UAV according to the unbinding instruction, the processor 401 may be further configured to:

receive unbinding result information returned by the UAV, and determine whether binding relationship between the user account and the UAV has been released according to the unbinding result information; and

send a motor-unlocking instruction to the UAV If the binding relationship between the user account and the UAV has been released, so that the UAV may set motors of the UAV to be in a unlocked state according to the motor-unlocking instruction.

It will be appreciated by those skilled in the art that working principles/processes in implementing the control terminal as described above can be substantially identical to those in implementing the aforementioned UAV activation method or UAV unbinding method and can be refer to the corresponding processes in the aforementioned embodiments of the UAV activation method or UAV unbinding method. A detailed description to the embodiments of the control terminal will be omitted for conciseness.

FIG. 8 illustrates a schematic structure block diagram of a UAV 500 according to an embodiment of the present disclosure. In one embodiment, the UAV 500 may include a rotary wing UAV, such as a quadrotor UAV, a hexarotor UAV, an octorotor UAV or the like. It may also be a fixed wing UAV or a combination of rotary wing type UAV and fixed-wing UAV. There is no limitation herein. Further, the UAV 500 may include a processor 501 and a storage medium 502 connected with the processor 501 via a bus 503, for example, the bus 503 may be an I2C (Inter-integrated Circuit) bus. The UAV 500 can be part of the system 600 shown in FIG. 10.

The processor 501 may be, but is not limited to, a micro-controller unit (MCU), a central processing unit (CPU), a digital signal processor (DSP), or the like.

The storage medium 502 may be, but is not limited to, a Flash chip, a read-only memory (ROM), a disk, an optical disk, a U disk, a mobile hard disk, or the like.

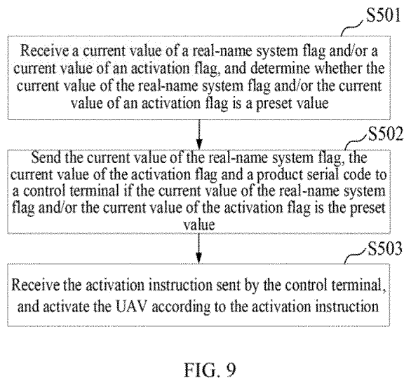

FIG. 9 illustrates a schematic step diagram of an activation operation performed by a UAV according to an embodiment of the present disclosure. The processor 501 can be configured to run a computer program stored in the storage medium 502, and implement steps S501 to S503 upon executing the computer program to perform the method shown in FIG. 9, for instance.

Step S501 may include receiving a current value of a real-name system flag and/or a current value of an activation flag, and determining whether the current value of the real-name system flag and/or the current value of the activation flag is a preset value.

The current value of the real-name system flag, the current value of the activation flag and a product serial code are stored in the UAV. The real-name system flag is used to identify whether the UAV has been real-named, the activation flag is used to identify whether the UAV has been activated for the first time, and the product serial code is used to uniquely identify the UAV. If a value of the real-name system flag is a preset value, the UAV is not real-named; if the value of the real-name system flag is not the preset value, the UAV is already real-named; if a value of the activation flag is a preset value, the UAV has not been activated for the first time, and if the value of the activation flag is not the preset value, the UAV has been activated for the first time.

When the UAV is turned on for the first time, a communication connection between the UAV and a control terminal is established. The UAV acquires a product serial code and sends the product serial code to the control terminal for the control terminal to send the product serial code to a server, and forwards an online real-name system identifier and an online activation identifier returned by the server based on the product serial code to the UAV; the UAV receives the online real-name system identifier and online activation identifier, based on the product serial code, returned by the control terminal, and configures the real-name system flag of the UAV according to the online real-name system identifier, and the activation flag of the UAV according to the online activation identifier. The online real-name system identifier is used to identify whether the state of the UAV in the server is a real-named state, and the online activation identifier is used to identify whether the state of the UAV in the server is the first time activation state.

After the UAV is configured with the real-name system flag and the activation flag, each time it establishes a communication connection with the control terminal, the UAV acquires the current value of the real-name system flag and/or the current value of the activation flag, and determines whether the current value of the real-name system flag and/or the current value of the activation flag is a preset value.

Step S502 may include: sending the current value of the real-name system flag, the current value of the activation flag and a product serial code to a control terminal if the current value of the real-name system flag and/or the current value of the activation flag is the preset value, where the control terminal generates a corresponding activation instruction based on the current value of the real-name system flag, the current value of the activation flag, and the product serial code, and sends the activation instruction to the UAV.

If the current value of the real-name system flag and/or the current value of the activation flag is the preset value, the current value of the real-name system flag, the current value of the activation flag and the product serial code are sent to the control terminal, where the control terminal generates a corresponding activation instruction based on the current value of the real-name system flag, the current value of the activation flag, and the product serial code, and sends the activation instruction to the UAV.

Step S503 may include: receiving the activation instruction sent by the control terminal, and activating the UAV according to the activation instruction.

The UAV receives the activation instruction sent by the control terminal, and activates the UAV according to the activation instruction. Specifically, a value of the real-name system flag, a value of the activation flag and a user account are obtained from the activation instruction; according to the value of the real-name system flag, the real-name system flag of the UAV is updated, and the account bound to the UAV is updated according to the user account; and the activation flag of the UAV is updated according to the value of the activation flag, and the UAV is activated. Or, the UAV obtains a value of the real-name system flag and a user account from the activation instruction, updates the real-name system flag of the UAV according to the value of the real-name system flag, updates the account bound to the UAV according to the user account and activates the UAV.

In one embodiment, when the current value of the real-name system flag is the preset value, the control terminal sends a motor-locking instruction to the UAV, and the UAV receives the motor-locking instruction sent by the control terminal, and sets the UAV to be in a locked state according to the motor-locking instruction. By locking motors of the UAV when the UAV is not activated, it can ensure that a user cannot use the UAV when the UAV is not activated, preventing unauthorized flying and improving safety.

In another embodiment, the UAV determines whether both the value of the updated real-name system flag and the value of the updated activation flag are not preset values; if both the value of the updated real-name system flag and the value of the updated activation flag are not the preset values, the motors of the UAV are set to be in an unlocked state. When the UAV is activated, the motors of the UAV are unlocked, so that the UAV can be used by the user, and the user experience is improved.

In yet another embodiment, the UAV receives an unbinding instruction sent by the control terminal, and according to the unbinding instruction, updates the real-name system flag of the UAV so that the current value of the real-name system flag sets to be the preset value to unbind the UAV. The whole unbinding process is simple and concise, and the UAV can be unbound quickly to improve user experience.

The embodiments of the present disclosure also provide a computer-readable storage medium, the computer-readable storage medium stores a computer program, the computer program includes program instructions. A processor implements the steps of the UAV activation method or the UAV unbinding method disclosed herein upon executing the program instructions.

The computer-readable storage medium may be the internal storage unit of the control terminal described in any of the foregoing embodiments, such as a hard disk or memory of the control terminal. The computer-readable storage medium may also be an external storage device of the control terminal, such as a plug-in hard disk, a smart memory card (Smart Media Card, SMC), a secure digital card (SD), Flash Card, or the like.

The present disclosure may be embodied as apparatus/equipment, a method, and/or a computer program product. The computer program product may include a computer readable storage medium on which computer program/computer readable program instructions are recorded that may cause one or more processors to carry out aspects of the embodiment. As noted above, operations, such as those set forth in the described methods can be respectively performed in whole or in part by the system 600 of FIG. 10, which notably can include the control terminal 400 of FIG. 7, the UAV 500 of FIG. 8, and a server system as described herein. As shown in FIG. 10, the control terminal 400 can communicate with the UAV 500 and the sever system via a network 700, which can include one or more wireless networks.

Further, the storage medium or the computer readable storage medium, such as storage medium 402 and/or storage medium 502 discussed above, may be a tangible device that can store instructions for use by an instruction execution device (e.g., a processor or multiple processors, such as distributed processors). The storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program and/or computer instructions described in this disclosure can be downloaded to an appropriate computing or processing device from a storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer program and/or computer instructions for implementing operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer program and/or computer instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flowchart and block diagrams of methods, apparatus/equipment (systems), and computer program products according to embodiments of the disclosure. It will be understood by those skilled in the art that each block of the flowchart and block diagrams, and combinations of blocks in the flow diagrams and block diagrams, can be implemented by computer program and/or computer instructions.

It should be understood that the terms used in the specification of the present disclosure are only for the purpose of describing specific embodiments and are not intended to limit the disclosure. As used in the specification of the present disclosure and the appended claims, unless the context clearly indicates otherwise, the singular forms “a”, “an” and “the” are intended to include plural forms. It should also be understood that the term “and/or” used in the description of this disclosure and the appended claims refers to any combination of one or more of the associated listed items and all possible combinations, and includes these combinations.

As noted above, numerous modifications and variations of the present disclosure are possible in light of the above teachings. It is therefore to be understood that within the scope of the appended claims, the disclosure may be practiced otherwise than as specifically described herein.

What is claimed is:

1. An unmanned aerial vehicle (UAV) activation method, said method comprising:
receiving, using an electronic processor, a current value of a real-name system flag, a current value of an activation flag, and a product serial code sent by a UAV, and determining, using the electronic processor, whether the current value of the real-name system flag is a preset value;
displaying, using the electronic processor, an activation confirmation page when the current value of the real-name system flag is determined to be the preset value, wherein the activation confirmation page comprises a user account;
when an activation confirmation operation of a user on the activation confirmation page is detected, sending, using the electronic processor, the product serial code and the user account to a server system corresponding to the current value of the activation flag so that the server system binds the product serial code with the user account; and
receiving activation result information sent by the server system, and activating the UAV according to the activation result information, using the electronic processor.

2. The method of claim 1, wherein: before said receiving the current value of the real-name system flag, the current value of the activation flag, and the product serial code sent by the UAV, the method further comprises:
receiving the product serial code sent by the UAV, and sending the product serial code to the server system, using the electronic processor;
receiving, using the electronic processor, an online real-name system identifier and an online activation identifier based on the product serial code returned by the server system; and
sending, using the electronic processor, a flag configuration instruction to the UAV according to the online real-name system identifier and the online activation identifier, so that the UAV configures the real-name system flag and the activation flag of the UAV according to the flag configuration instruction.

3. The method of claim 1, wherein: before said determining whether the current value of the real-name system flag is the preset value, the method further comprises:
acquiring a geographic location coordinate of the UAV, and determining whether the UAV is located in a preset region according to the geographic location coordinate, using the electronic processor; and
determining, using the electronic processor, whether the current value of the real-name system flag is the preset value when the UAV is determined to be located in the preset region.

4. The method of claim 3, further comprising:
determining, using the electronic processor, whether the user account is a mobile phone number whose attribution is located in the preset region when the current value of the real-name system flag is the preset value;
displaying an activation page when the user account is not the mobile phone number whose attribution is located in the preset region, acquiring a verification code entered by the user on the activation page, and verifying the verification code, using the electronic processor; and
displaying, using the electronic processor, the activation confirmation page when the verification code passes verification.

5. The method of claim 4, further comprising:
displaying, using the electronic processor, the activation confirmation page when the user account is the mobile phone number whose attribution is located in the preset region.

6. The method of claim 3, further comprising:
displaying, using the electronic processor, the activation confirmation page when the UAV is not located in the preset region.

7. The method of claim 1, wherein: before said displaying the activation confirmation page, the method further comprises:
determining, using the electronic processor, whether a control terminal is in an account logged-in state when the current value of the real-name system flag is determined to be the preset value; and
displaying, using the electronic processor, the activation confirmation page when the control terminal is determined to be in the account logged-in state, wherein the activation confirmation page comprises a logged-in user account as said user account.

8. The method of claim 7, further comprising:
displaying, using the electronic processor, an account login page to remind the user to log in or register an account when the control terminal is not in the account logged-in state;
when a registration instruction triggered by the user on the account login page is detected, displaying, using the electronic processor, a corresponding account registration page according to the registration instruction;
acquiring the user account, a user password, and a verification code entered by the user on the account registration page, and verifying the verification code, using the electronic processor; and
when the verification code passes verification, performing, using the electronic processor, an account login operation according to the user account and the user password, so that the control terminal is in the account logged-in state.

9. The method of claim 1, wherein the binding the product serial code with the user account performed by the server system comprises:
determining whether the current value of the activation flag is the preset value;
when the current value of the activation flag is determined to be the preset value, uploading the product serial code and the user account to an activation server of the server system so that the activation server binds the user account with the product serial code, and then sending the user account and the product serial code to a real-name system server of the server system so that the real-name system server binds the user account with the product serial code; and
when the current value of the activation flag is determined not to be the preset value, uploading the product serial code and the user account to the real-name system server, so that the real-name system server binds the user account with the product serial code.

10. The method of claim 9, wherein the activating the UAV according to the activation result information further comprises:
receiving, using the electronic processor, an online activation identifier returned by the activation server and an online real-name system identifier returned by the real-name system server;
updating the activation flag of the UAV according to the online activation identifier, updating the real-name system flag according to the online real-name system identifier, and updating a bound account of the UAV to the user account, using the electronic processor; or
receiving the online real-name system identifier returned by the real-name system server, updating the real-name system flag according to the online real-name system identifier, and updating the bound account of the UAV to the user account, using the electronic processor.

11. The method of claim 1, further comprising:
when the current value of the real-name system flag is the preset value, sending, using the electronic processor, a motor-locking instruction to the UAV, so that the UAV sets one or more motors of the UAV to be in a locked state according to the motor-locking instruction.

12. The method of claim 11, further comprising:
after the UAV is activated, sending, using the electronic processor, a motor-unlocking instruction to the UAV, so that the UAV sets the one or more motors of the UAV to be in an unlocked state according to the motor-unlocking instruction.

13. A control terminal, comprising:
a storage medium that stores a computer program comprising computer-executable instructions; and
a processor configured to access the storage medium,
wherein the processor is configured to execute the computer program to:
receive a current value of a real-name system flag, a current value of an activation flag, and a product serial code sent by an unmanned aerial vehicle (UAV), and determine whether the current value of the real-name system flag is a preset value;
display an activation confirmation page when the current value of the real-name system flag is the preset value, wherein the activation confirmation page comprises a user account;
when an activation confirmation operation of a user on the activation confirmation page is detected, send the product serial code and the user account to a server system corresponding to the current value of the activation flag so that the server system binds the product serial code with the user account; and
receive activation result information sent by the server system corresponding to the current value of the activation flag, and activate the UAV according to the activation result information.

14. The control terminal of claim 13, wherein: before receiving the current value of the real-name system flag, the current value of the activation flag, and the product serial code sent by the UAV, the processor is further configured to:
receive the product serial code sent by the UAV, and send the product serial code to the server system;
receive an online real-name system identifier and an online activation identifier based on the product serial code returned by the server system; and
send a flag configuration instruction to the UAV according to the online real-name system identifier and the online activation identifier, so that the UAV configures the real-name system flag and the activation flag of the UAV according to the flag configuration instruction.

15. The control terminal of claim 13, wherein before determining whether the current value of the real-name system flag is the preset value, the processor is further configured to:
acquire a geographic location coordinate of the UAV, and determine whether the UAV is located in a preset region according to the geographic location coordinate; and
determine whether the current value of the real-name system flag is the preset value when the UAV is determined to be located in the preset region.

16. The control terminal of claim 15, wherein the processor is further configured to:
determine whether the user account is a mobile phone number whose attribution is located in the preset region when the current value of the real-name system flag is the preset value;
display an activation page when the user account is not the mobile phone number whose attribution is located in the preset region, acquire a verification code entered by the user on the activation page, and verify the verification code; and
display the activation confirmation page when the verification code passes verification; or
display the activation confirmation page when the user account is the mobile phone number whose attribution is located in the preset region.

17. The control terminal of claim 13, wherein before displaying the activation confirmation page, the processor is further configured to:
determine whether the control terminal is in an account logged-in state when the current value of the real-name system flag is determined to be the preset value; and
display the activation confirmation page when the control terminal is determined to be in the account logged-in state, wherein the activation confirmation page comprises a logged-in user account as said user account; or
display an account login page to remind the user to log in or register an account when the control terminal is not in the account logged-in state;
when a registration instruction triggered by the user on the account login page is detected, display a corresponding account registration page according to the registration instruction;
acquire the user account, a user password and a verification code entered by the user on the account registration page, and verify the verification code; and
when the verification code passes verification, perform an account login operation according to the user account and the user password, so that the control terminal is in the account logged-in state.

18. The control terminal of claim 13, wherein when the processor implements sending the product serial code and the user account to the server system corresponding to the current value of the activation flag so that the server system binds the product serial code with the user account, the processor is configured to:
determine whether the current value of the activation flag is the preset value;
when the current value of the activation flag is determined to be the preset value, upload the product serial code and the user account to an activation server of the server system so that the activation server binds the user account with the product serial code, and then send the user account and the product serial code to a real-name system server of the server system so that the real-name system server binds the user account with the product serial code; and
when the current value of the activation flag is determined not to be the preset value, upload the product serial code and the user account to the real-name system server so that the real-name system server binds the user account with the product serial code.

19. The control terminal of claim 18, wherein when activating the UAV according to the activation result information, the processor is further configured to:
receive an online activation identifier returned by the activation server and an online real-name system identifier returned by the real-name system server;
update the activation flag of the UAV according to the online activation identifier, update the real-name system flag according to the online real-name system identifier, and update a bound account of the UAV to the user account; or
receive the online real-name system identifier returned by the real-name system server, update the real-name system flag according to the online real-name system identifier, and update the bound account of the UAV to the user account.

20. The control terminal of claim 13, wherein the processor is further configured to:
when the current value of the real-name system flag is the preset value, send a motor-locking instruction to the UAV, so that the UAV sets one or more motors of the UAV to be in a locked state according to the motor-locking instruction; and
after the UAV is activated, send a motor-unlocking instruction to the UAV, so that the UAV sets the one or more motors of the UAV to be in an unlocked state according to the motor-unlocking instruction.
